(19) United States
(12) Patent Application Publication
(10) Pub. No.: US 2012/0182228 A1
(43) Pub. Date: Jul. 19, 2012

(54) METHOD AND APPARATUS FOR DETECTING TOUCH POINT MOVEMENT

(75) Inventors: Jui-Ming Liu, Tainan County (TW); Chung-Wen Chang, Tainan County (TW); Feng-Wei Yang, Tainan County (TW); Shen-Feng Tai, Tainan County (TW)

(73) Assignee: HIMAX TECHNOLOGIES LIMITED, Tainan County (TW)

(21) Appl. No.: 13/009,399

(22) Filed: Jan. 19, 2011

(51) Int. Cl. G06F 3/041

(52) U.S. Cl. 345/173

(57) ABSTRACT

A method and an apparatus for detecting a touch point movement are provided. In the present method, a touch panel is detected to obtain the positions of m previous touch points Pᵢ during a frame period and the positions of n current touch points Pⱼ′ during another frame period. Distances D_{(i,j)} between the previous touch points Pᵢ and the current touch points Pⱼ′ are calculated, and a minimum distance among valid ones of the distances D_{(i,j)} is found out. If a distance D_{(a,b)} among the distances D_{(i,j)} is the minimum distance, the current touch point P_{b}′ is defined as a touch point moved from the previous touch point Pₐ, and the distances D_{(a,1)}-D_{(a,n)} and the distances D_{(1,b)}-D_{(m,b)} are defined as invalid values.

### BACKGROUND OF THE INVENTION

1. Field of the Invention

The invention generally relates to a touch panel, and more particularly, to a method and an apparatus for detecting a touch point movement.

2. Description of Related Art

Most existing touch panels support multi-point touch function. Touch points usually move on a touch panel randomly, and how to detect the movement of these touch points is a major subject to some applications. For example, if a system detects a touch point at a first position on a touch panel during a specific frame period and a touch point at a second position on the touch panel during a next frame period, the system determines that the touch point moves from the first position to the second position. However, the detection becomes complicated when there are multiple touch points on the touch panel. If the system detects three previous touch points P₁, P₂, and P₃ on the touch panel during a specific frame period and two current touch points P₁′ and P₂′ on the touch panel during a next frame period, obviously, one of the three touch points is removed. The system cannot determine which one of the previous touch points P₁, P₂, and P₃ is removed or the current touch points P₁′ and P₂′ are respectively moved from which one of the previous touch points without adopting a technique for detecting touch point movement.

### SUMMARY OF THE INVENTION

Accordingly, the invention is directed to a method and an apparatus for detecting a touch point movement, wherein a movement relationship between previous touch points and current touch points is determined.

According to an embodiment of the invention, a method for detecting a touch point movement is provided. In the present method, a touch panel is detected to obtain the positions of m previous touch points Pᵢ during a specific frame period and the positions of n current touch points Pⱼ′ during another frame period, wherein m and n are integers, i is an integer between 1 and m, and j is an integer between 1 and n. Distances D_{(i,j)} between the previous touch points Pᵢ and the current touch points Pⱼ′ are calculated. A minimum distance among the valid ones of the distances D_{(i,j)} is found out. If a distance D_{(a,b)} among the distances D_{(i,j)} is the minimum distance, the current touch point P_{b}′ is defined as a touch point moved from the previous touch point Pₐ, and the distances D_{(a,1)}-D_{(a,n)} and the distances D_{(1,b)}-D_{(m,b)} are defined as invalid values.

According to an embodiment of the invention, an apparatus for detecting a touch point movement is provided. The apparatus includes a touch panel, a driving unit, and a processing unit. The driving unit drives and detects the touch panel to output a detection result. The processing unit receives the detection result and obtains the positions of m previous touch points Pᵢ during a specific frame period (m is an integer and i is an integer between 1 and m) and the positions of n current touch points Pⱼ′ during another frame period (n is an integer and j is an integer between 1 and n) according to the detection result. The processing unit calculates distances D_{(i,j)} between the previous touch points Pᵢ and the current touch points Pⱼ′ and finds out a minimum distance among the valid ones of the distances D_{(i,j)}. If a distance D_{(a,b)} among the distances D_{(i,j)} is the minimum distance, the processing unit defines the current touch point P_{b}′ as a touch point moved from the previous touch point Pₐ and defines the distances D_{(a,1)}-D_{(a,n)} and the distances D_{(1,b)}-D_{(m,b)} as invalid values.

According to an embodiment of the invention, the step of defining the current touch point P_{b}′ as the touch point moved from the previous touch point Pₐ includes allowing the current touch point P_{b}′ to inherit an identification (ID) code or an attribute from the previous touch point Pₐ.

As described above, in an embodiment of the invention, the distances D_{(i,j)} between all the previous touch points Pᵢ and all the current touch points Pⱼ′ are calculated, and a movement relationship between the previous touch points Pᵢ and the current touch points Pⱼ′ is determined by analyzing these distances D_{(i,j)}.

These and other features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus for detecting a touch point movement according to an embodiment of the invention.

FIG. 2 is a flowchart of a method for detecting a touch point movement according to an embodiment of the invention.

FIGS. 3A-3C illustrate the positions of touch points on a touch panel respectively obtained during a previous and a current frame periods according to an embodiment of the invention.

FIG. 4A and FIG. 4B illustrate the positions of touch points on a touch panel respectively obtained during a previous and a current frame periods according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

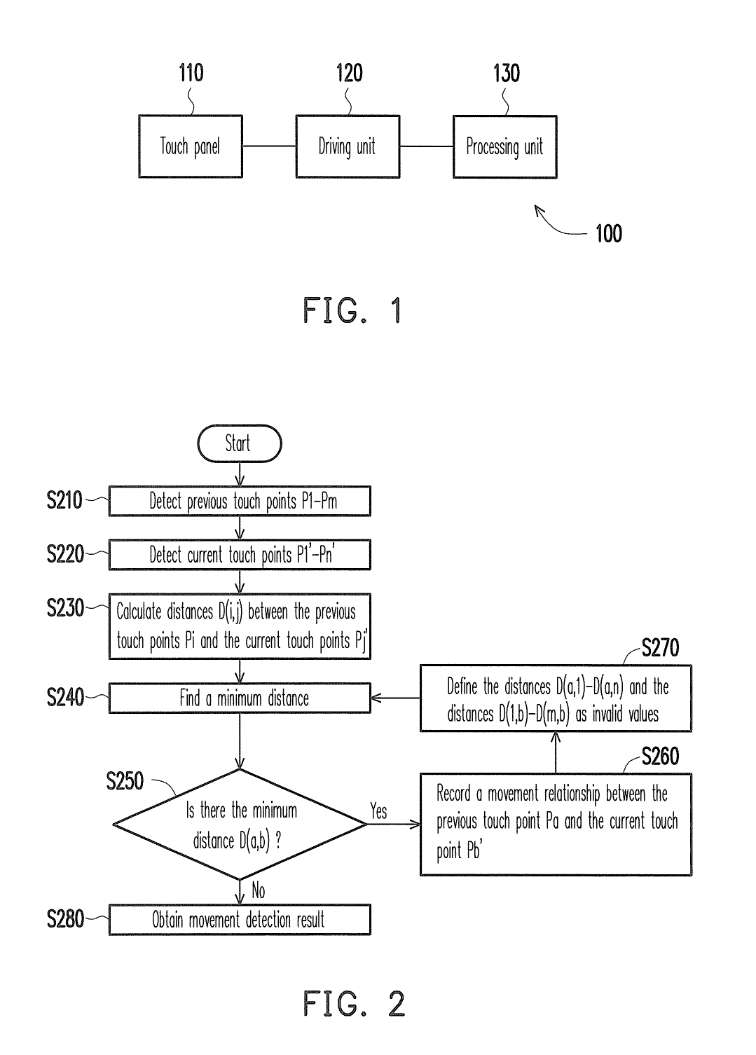

FIG. 1 is a block diagram of an apparatus 100 for detecting a touch point movement according to an embodiment of the invention. The apparatus 100 includes a touch panel 110, a driving unit 120, and a processing unit 130. The driving unit 120 drives and detects the touch panel 110 to output a detection result. The processing unit 130 receives and analyzes the detection result. The touch panel 110 may be a touch panel of any type, such as a capacitive touch panel, a resistive touch panel, or an optical touch panel. The driving unit 120, in correspondence to the touch panel 110, may be a driving/detecting circuit of any type. The touch panel 110 and the corresponding driving unit 120 are well-known techniques therefore will not be described herein.

The processing unit 130 obtains the positions of m previous touch points Pᵢ during a specific frame period (m and i are integers and i is between 1 and m) and the positions of n current touch points P^{j}′ during another frame period (n and j are integers and j is between 1 and n) according to the detection result (original detection data) output by the driving unit 120. The technique (i.e., positioning algorithm) of determining the positions of the touch points based on the detection result output by the driving unit 120 is also a well-known technique therefore will not be described herein. The positioning algorithm adopted by the driving unit 120 is not limited in the present embodiment.

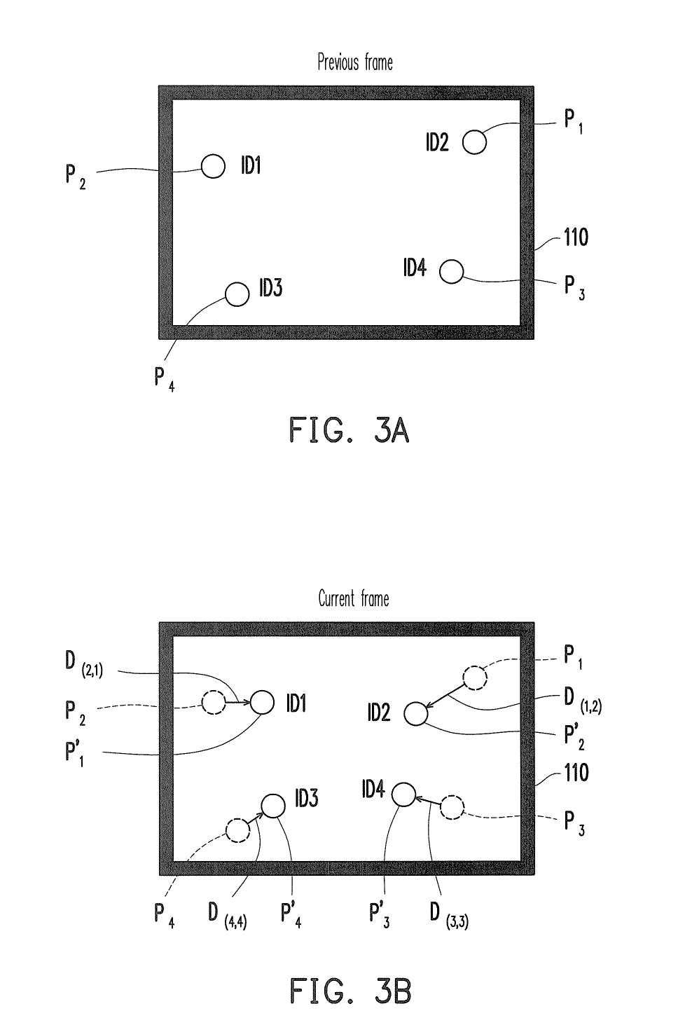

FIG. 2 is a flowchart of a method for detecting a touch point movement according to an embodiment of the invention. Referring to FIG. 1 and FIG. 2, the processing unit 130 detects the touch panel 110 through the driving unit 120 to obtain the positions of the previous touch points Pᵢ (i.e., P₁-Pₘ) (step S210) and the positions of the current touch points Pⱼ′ (i.e., P₁′-Pₙ′) (step S220).

The processing unit 130 calculates the distances D_{(i,j)} between the previous touch points Pᵢ and the current touch points Pⱼ′ (step S230) and finds out a minimum distance among the valid ones of the distances D_{(i,j)} (step S240). In step S250, the processing unit 130 determines whether there is the minimum distance among the valid ones of the distances D_{(i,j)}. If a distance D_{(a,b)} among the distances D_{(i,j)} is the minimum distance, the processing unit 130 defines the current touch point P_{b}′ as a new touch point moved from the previous touch point Pₐ (step S260). In the present embodiment, the processing unit 130 records a movement relationship between the current touch point P_{b}′ and the previous touch point Pₐ into a recording medium (step S260). In another embodiment, the processing unit 130 records an index b of the current touch point P_{b}′ and an identification (ID) code or an attribute of the previous touch point Pₐ into a recording medium (step S260). In other embodiments, the processing unit 130 makes the current touch point P_{b}′ to inherit an ID code or an attribute from the previous touch point Pₐ (step S260).

Next, the processing unit 130 defines the distances D_{(a,1)}, D_{(a,2)}, . . . , and D_{(a,n)} and the distances D_{(1,b)}, D_{(2,b)}, . . . , and D_{(m,b)} as invalid values (step S270). How the distances D_{(a,1)}-D_{(a,n)} and the distances D_{(1,b)}-D_{(m,b)} are defined as invalid values in step S270 is not limited in the present embodiment. Taking the distance D_{(a,1)} as an example, the processing unit 130 can determine that the distance D_{(a,1)} is invalid by setting the distance D_{(a,1)} to a maximum value, wherein the maximum value (for example, of 16 bits) is ffff (HEX). Or, the processing unit 130 can set the distance D_{(a,1)} to a predetermined value (for example, 0, eeee (HEX), or any other specific value) and determine whether the distance D_{(a,1)} is valid according to the value of the distance D_{(a,1)}. In other embodiments, the distances D_{(i,j)} respectively have a corresponding flag, and the processing unit 130 can determine whether the distance D_{(a,1)} is valid by reading the corresponding flag of the distance D_{(a,1)}.

After step S270, the processing unit 130 executes steps S240 and S250 again until all the distances D_{(i,j)} are defined as invalid values (i.e., the processing unit 130 cannot find any minimum distance D_{(a,b)} among the distances D_{(i,j)}). In step S280, the processing unit 130 obtains a detection result of the touch point movement (i.e., the result recorded in step S260). In some other embodiments, if n is greater than m (i.e., the number of current touch points is greater than the number of previous touch points), in step S280, the processing unit 130 correspondingly assigns at least one new ID code or at least one new attribute to at least one of the current touch points P₁′-Pₙ′ that does not inherit any ID code or attribute.

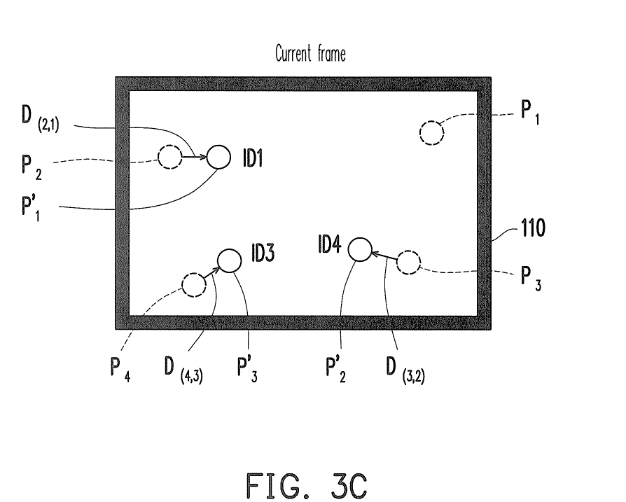

FIG. 3A and FIG. 3B illustrate the positions of touch points on the touch panel 110 respectively obtained by the processing unit 130 during a previous and a current frame periods according to an embodiment of the invention. Referring to FIG. 3A, in step S210, the processing unit 130 obtains the positions of four previous touch points P₁, P₂, P₃, and P₄ during a previous frame period according to the detection result of the driving unit 120, wherein the four previous touch points P₁-P₄ respectively have the ID codes ID2, ID1, ID4, and ID3. Referring to FIG. 3A, in step S220, the processing unit 130 obtains the positions of four current touch points P₁′, P₂′, P₃′, and P₄′ during a current frame period according to the detection result of the driving unit 120. Based on the touch point positions obtained in steps S210 and S220, in step S230, the processing unit 130 calculates the distances D_{(i,j)} between the previous touch points Pᵢ and the current touch points Pⱼ′. The distances D_{(i,j)} are listed in following table 1.

TABLE 1
distances D_{(i, j)} between previous touch
points Pᵢ and current touch points Pⱼ′

| | P₁ | P₂ | P₃ | P₄ |
|---|---|---|---|---|
| P₁′ | D_{(1, 1)} | D_{(2, 1)} | D_{(3, 1)} | D_{(4, 1)} |
| P₂′ | D_{(1, 2)} | D_{(2, 2)} | D_{(3, 2)} | D_{(4, 2)} |
| P₃′ | D_{(1, 3)} | D_{(2, 3)} | D_{(3, 3)} | D_{(4, 3)} |
| P₄′ | D_{(1, 4)} | D_{(2, 4)} | D_{(3, 4)} | D_{(4, 4)} |

Next, in step S240, the processing unit 130 finds a minimum distance among valid ones of the distances D_{(i,j)} (step S240). Presently, all the D_{(i,i)} are valid and the distance D_{(4,4)} is assumed to be the minimum distance among all the valid distances D_{(i,j)}. Thus, in step S260, the processing unit 130 defines the current touch point P₄′ as a new touch point moved from the previous touch point P₄. Namely, in step S260 of the present embodiment, the index “4” of the current touch point P₄′ and the ID code “ID3” of the previous touch point P₄ are recorded into a recording medium (i.e., the current touch point P₄′ inherits the ID code “ID3” from the previous touch point P₄).

After that, in step S270, the processing unit 130 defines the distances D_{(4,1)}, D_{(4,2)}, D_{(4,3)}, D_{(4,4)}, D_{(1,4)}, D_{(2,4)}, and D_{(3,4)} as invalid values (step S270). Herein the maximum value ffff (HEX) is defined as the invalid values. The distances D_{(i,j)} after step S270 is executed are listed in following table 2.

TABLE 2
distances D_{(i, j)} between previous touch
points Pᵢ and current touch points Pⱼ′

| | P₁ | P₂ | P₃ | P₄ |
|---|---|---|---|---|
| P₁′ | D_{(1, 1)} | D_{(2, 1)} | D_{(3, 1)} | ffff |
| P₂′ | D_{(1, 2)} | D_{(2, 2)} | D_{(3, 2)} | ffff |
| P₃′ | D_{(1, 3)} | D_{(2, 3)} | D_{(3, 3)} | ffff |
| P₄′ | ffff | Ffff | ffff | ffff |

After step S270, the processing unit 130 executes steps S240 and S250 again. Herein there are still valid distances D_{(i,j)} in table 2 and the distance D_{(2,1)} is assumed to be the minimum distance among all the valid distances D_{(i,j)} in table 2. Thus, in step S260, the processing unit 130 defines the current touch point P₁′ as a new touch point moved from the previous touch point P₂. Namely, in step S260, the index “1” of the current touch point P₁′ and the ID code “ID1” of the previous touch point P₂ are recorded into a recording medium (i.e., the current touch point P₁′ inherits the ID code “ID1” from the previous touch point P₂).

Thereafter, in step S270, the processing unit 130 defines the distances D_{(2,1)}, D_{(2,2)}, D_{(2,3)}, D_{(2,4)}, D_{(1,1)}, D_{(3,1)}, and D_{(4,1)} as invalid values. The distances D_{(i,j)} after step S270 is executed are listed in following table 3.

TABLE 3
distances D_{(i, j)} between previous touch
points Pᵢ and current touch points Pⱼ′

| | P₁ | P₂ | P₃ | P₄ |
|---|---|---|---|---|
| P₁′ | ffff | ffff | ffff | ffff |
| P₂′ | D_{(1, 2)} | ffff | D_{(3, 2)} | ffff |
| P₃′ | D_{(1, 3)} | ffff | D_{(3, 3)} | ffff |
| P₄′ | ffff | ffff | ffff | ffff |

After step S270, the processing unit 130 executes steps S240 and S250 again. Herein there are still valid distances D_{(i,j)} in table 3 and the distance D_{(3,3)} is assumed to be the minimum distance among all the valid distances D_{(i,j} in table 3. Thus, in step S260, the processing unit 130 defines the current touch point P₃′ as a new touch point moved from the previous touch point P₃. Namely, in step S260, the index “3” of the current touch point P₃′ and the ID code “ID4” of the previous touch point P₃ are recorded into a recording medium (i.e., the current touch point P₃′ inherits the ID code “ID4” from the previous touch point P₃).

After that, in step S270, the processing unit 130 defines the distances D_{(3,1)}, D_{(3,2)}, D_{(3,3)}, D_{(3,4)}, D_{(1,3)}, D_{(2,3)}, and D_{(4,3)} as invalid values. The distances D_{(i,j)} after the step S270 is executed are listed in following table 4.

TABLE 4
distances D_{(i, j)} between previous touch
points Pᵢ and current touch points Pⱼ′

| | P₁ | P₂ | P₃ | P₄ |
|---|---|---|---|---|
| P₁′ | ffff | ffff | ffff | ffff |
| P₂′ | D_{(1, 2)} | ffff | ffff | ffff |
| P₃′ | ffff | ffff | ffff | ffff |
| P₄′ | ffff | ffff | ffff | ffff |

After step S270, the processing unit 130 executes the steps S240 and S250 again. Herein there are still valid distances D_{(i,j)} in table 4 and the distance D_{(1,2)} is assumed to be the minimum distance among all the valid distances D_{(i,j)} in table 4. Thus, in step S260, the processing unit 130 defines the current touch point P₂′ as a new touch point moved from the previous touch point P₁. Namely, in step S260, the index “2” of the current touch point P₂′ and the ID code “ID2” of the previous touch point P₁ are recorded into a recording medium (i.e., the current touch point P₂′ inherits the ID code “ID2” from the previous touch point P₁).

After that, in step S270, the processing unit 130 defines the distances D_{(1,1)}, D_{(1,2)}, D_{(1,3)}, D_{(1,4)}, D_{(2,2)}, D_{(3,2)}, and D_{(4,2)} as invalid values. The distances D_{(i,j)} after the step S270 is executed are listed in following table 5.

TABLE 5
distances D_{(i, j)} between previous touch
points Pᵢ and current touch points Pⱼ′

| | P₁ | P₂ | P₃ | P₄ |
|---|---|---|---|---|
| P₁′ | ffff | ffff | ffff | ffff |
| P₂′ | ffff | ffff | ffff | ffff |
| P₃′ | ffff | ffff | ffff | ffff |
| P₄′ | ffff | ffff | ffff | ffff |

After step S270, the processing unit 130 executes steps S240 and S250 again. Since there is no more valid distance among the distances D_{(i,j)} in table 5 (i.e., the processing unit 130 cannot find any minimum distance D_{(a,b)} among the distances D_{(i,j)}), the processing unit 130 obtains the detection result of the touch point movement (i.e., the result recorded in step S260).

FIG. 3C illustrates the positions of the touch points in FIG. 3A after they are moved on the touch panel 110 according to another embodiment of the invention. Referring to FIG. 3A, in step S210, the processing unit 130 obtains the positions of four previous touch points P₁, P₂, P₃, and P₄ during a previous frame period according to a detection result of the driving unit 120, wherein the four previous touch points P₁-P₄ respectively have the ID codes ID2, ID1, ID4, and ID3. Referring to FIG. 3C, in step S220, the processing unit 130 obtains the positions of three current touch points P₁′, P₂′, and P₃′ during a current frame period according to the detection result of the driving unit 120.

The process for detecting touch point movement in the present embodiment can be referred to the descriptions of foregoing embodiments. However, the difference between the present embodiment and foregoing embodiments is that in the present embodiment, a user removes the touch point P₁ from the four previous touch points P₁-P₄ so that only three current touch points P₁′-P₃′ are left during the current frame period, as shown in FIG. 3C. Referring to the descriptions of foregoing embodiments, in step S230 of the present embodiment, the processing unit 130 calculates the distances D_{(i,j)} between the previous touch points Pᵢ and the current touch points Pᵢ'. The distances D_{(i,j)} are listed in following table 6.

TABLE 6
distances D_{(i, j)} between previous touch
points Pᵢ and current touch points Pⱼ′

| | P₁ | P₂ | P₃ | P₄ |
|---|---|---|---|---|
| P₁′ | D_{(1, 1)} | D_{(2, 1)} | D_{(3, 1)} | D_{(4, 1)} |
| P₂′ | D_{(1, 2)} | D_{(2, 2)} | D_{(3, 2)} | D_{(4, 2)} |
| P₃′ | D_{(1, 3)} | D_{(2, 3)} | D_{(3, 3)} | D_{(4, 3)} |
| P₄′ | ffff | ffff | ffff | ffff |

A current touch point P₄′ is added to foregoing table 6 to form a 4×4 array. Because the current touch point P₄′ does not really exist, the distances D_{(1,4)}-D_{(4,4)} between the current touch point P₄′ and previous touch points P₁-P₄ in table 6 are set to an invalid value (herein the maximum value ffff). The process for detecting the touch point movement in the embodiment corresponding to table 6 can be referred to the descriptions corresponding to foregoing tables 1-5 therefore will not be described herein.

In another embodiment, the processing unit 130 does not add the current touch point P₄′. Instead, the processing unit 130 detects the touch point movement based on the actually detected distances between the previous touch points P_{I}-P₄ and the current touch points P₁′-P₃′. As shown in following table 7, in step S230, the processing unit 130 calculates the distances D_{(i,j)} between the previous touch points Pᵢ and the current touch points Pⱼ′ in FIG. 3C.

TABLE 7
distances D_{(i, j)} between previous touch
points Pᵢ and current touch points Pⱼ′

| | P₁ | P₂ | P₃ | P₄ |
|---|---|---|---|---|
| P₁′ | D_{(1, 1)} | D_{(2, 1)} | D_{(3, 1)} | D_{(4, 1)} |
| P₂′ | D_{(1, 2)} | D_{(2, 2)} | D_{(3, 2)} | D_{(4, 2)} |
| P₃′ | D_{(1, 3)} | D_{(2, 3)} | D_{(3, 3)} | D_{(4, 3)} |

Next, in step S240, the processing unit 130 finds out a minimum distance among valid ones of the distances D_{(i,j)} (step S240). Herein all the distances D_{(i,j)} in table 7 are valid and the distance D_{(4,3)} is assumed to be the minimum distance among all the valid distances D_{(i,j)}. Thus, in step S260, the processing unit 130 defines the current touch point P₃′ as a new touch point moved from the previous touch point P₄. In step S260 of the present embodiment, the index “3” of the current touch point P₃′ and the ID code “ID3” of the previous touch point P₄ are recorded into a recording medium (i.e., the current touch point P₃′ inherits the ID code “ID3” from the previous touch point P₄). After that, in step S270, the processing unit 130 defines the distances D_{(4,1)}, D_{(4,2)}, D_{(4,3)}, D_{(1,3)}, D_{(2,3)}, and D_{(3,3)} as invalid values, as shown in following table 8.

TABLE 8
distances D_{(i, j)} between previous touch
points Pᵢ and current touch points Pⱼ′

| | P₁ | P₂ | P₃ | P₄ |
|---|---|---|---|---|
| P₁′ | D_{(1, 1)} | D_{(2, 1)} | D_{(3, 1)} | ffff |
| P₂′ | D_{(1, 2)} | D_{(2, 2)} | D_{(3, 2)} | ffff |
| P₃′ | ffff | ffff | ffff | ffff |

After step S270, the processing unit 130 executes steps S240 and S250 again. Herein the distance D_{(2,1)} is assumed to be the minimum distance among all the valid distances D_{(i,j)} in table 8. Thus, in step S260, the processing unit 130 defines the current touch point P₁′ as a new touch point moved from the previous touch point P₂. Namely, in step S260, the index “1” of the current touch point P₁′ and the ID code “ID1” of the previous touch point P₂ are recorded into a recording medium (i.e., the current touch point P₁′ inherits the ID code “ID1” from the previous touch point P₂). After that, in step S270, the processing unit 130 defines the distances D_{(2,1)}, D_{(2,2)}, D_{(2,3)}, D_{(1,1)}, D_{(3,1)}, and D_{(4,1)} as invalid values, as shown in following table 9.

TABLE 9
distances D_{(i, j)} between previous touch
points Pᵢ and current touch points Pⱼ′

| | P₁ | P₂ | P₃ | P₄ |
|---|---|---|---|---|
| P₁′ | ffff | ffff | ffff | ffff |
| P₂′ | D_{(1, 2)} | ffff | D_{(3, 2)} | ffff |
| P₃′ | ffff | ffff | ffff | ffff |

After step S270, the processing unit 130 executes steps S240 and S250 again. Herein the distance D_{(3,2)} is assumed to be the minimum distance among all the valid distances D_{(i,j)} in table 9. Thus, in step S260, the processing unit 130 defines the current touch point P₂′ as a new touch point moved from the previous touch point P₃. Namely, in step S260, the index “2” of the current touch point P₂′ and the ID code “ID4” of the previous touch point P₃ are recorded into a recording medium (i.e., the current touch point P₂′ inherits the ID code “ID4” from the previous touch point P₃). After that, in step S270, the processing unit 130 defines the distances D_{(3,1)}, D_{(3,2)}, D_{(3,3)}, D_{(1,2)}, D_{(2,2)}, and D_{(4,2)} as invalid values, as shown in following table 10.

TABLE 10
distances D_{(i, j)} between previous touch
points Pᵢ and current touch points Pⱼ′

| | P₁ | P₂ | P₃ | P₄ |
|---|---|---|---|---|
| P₁′ | ffff | ffff | ffff | ffff |
| P₂′ | ffff | ffff | ffff | ffff |
| P₃′ | ffff | ffff | ffff | ffff |

After step S270, the processing unit 130 executes steps S240 and S250 again. Since there is no more valid distance among the distances D_{(i,j)} in table 10 (i.e., the processing unit 130 cannot find any minimum distance D_{(a,b)} among the distances D_{(i,j)}), the processing unit 130 obtains the detection result of the touch point movement (i.e., the result recorded in step S260).

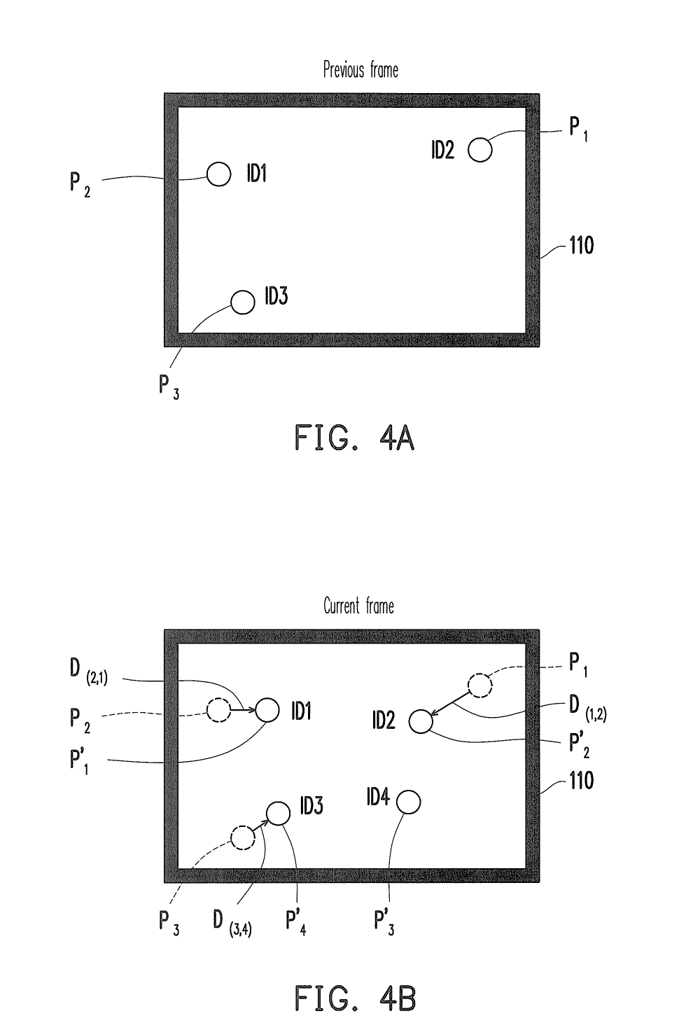

In some other embodiments, if n is greater than m (i.e., the number of current touch points is greater than the number of previous touch points), in step S280, the processing unit 130 correspondingly assigns at least one new ID code or at least one new attribute to at least one of the current touch points P₁′-Pₙ′ that does not inherit any ID code or attribute. FIG. 4A and FIG. 4B illustrate the positions of touch points on the touch panel 110 respectively obtained by the processing unit 130 during a previous and a current frame periods according to yet another embodiment of the invention. Referring to FIG. 4A, in step S210, the processing unit 130 obtains the positions of three previous touch points P₁, P₂, and P₃ during a previous frame period according to a detection result of the driving unit 120, wherein the three previous touch points P₁-P₃ respectively have the ID codes ID2, ID1, and ID3. Referring to FIG. 4B, in step S220, the processing unit 130 obtains the positions of four current touch points P₁′, P₂′, P₃′, and P₄′ during a current frame period according to the detection result of the driving unit 120.

The process for detecting touch point movement in the present embodiment can be referred to the descriptions of foregoing embodiments. However, the difference between the present embodiment and foregoing embodiments is that in the present embodiment, a user adds a new touch point to the three previous touch points P₁-P₃ so that there are four current touch points, as shown in FIG. 4B. Referring to the descriptions of foregoing embodiments, in step S230 of the present embodiment, the processing unit 130 calculates the distances D_{(i,j)} between the previous touch points Pᵢ and the current touch points Pⱼ′. The distances D_{(i,j)} are listed in following table 11.

TABLE 11
distances D_{(i, j)} between previous touch
points Pᵢ and current touch points Pⱼ′

| | P₁ | P₂ | P₃ |
|---|---|---|---|
| P₁′ | D_{(1, 1)} | D_{(2, 1)} | D_{(3, 1)} |
| P₂′ | D_{(1, 2)} | D_{(2, 2)} | D_{(3, 2)} |
| P₃′ | D_{(1, 3)} | D_{(2, 3)} | D_{(3, 3)} |
| P₄′ | D_{(1, 4)} | D_{(2, 4)} | D_{(3, 4)} |

Thereafter, in step S240, the processing unit 130 finds a minimum distance among valid ones of the distances D_{(i,j)}. Herein all the distances D_{(i,j)} in table 11 are valid and the distance D_{(3,4)} is assumed to be the minimum distance among all the valid distances D_{(i,j)}. Thus, in step S260, the processing unit 130 defines the current touch point P₄′ as a new touch point moved from the previous touch point P₃. Namely, in step S260 of the present embodiment, the index “4” of the current touch point P₄′ and the ID code “ID3” of the previous touch point P₃ are recorded into a recording medium (i.e., the current touch point P₄′ inherits the ID code “ID3” from the previous touch point P₃). After that, in step S270, the processing unit 130 defines the distances D_{(3,1)}, D_{(3,2)}, D_{(3,3)}, D_{(3,4)}, D_{(1,4)}, and D_{(2,4)} as invalid values, as shown in following table 12.

TABLE 12
distances D_{(i, j)} between previous touch
points Pᵢ and current touch points Pⱼ′

| | P₁ | P₂ | P₃ |
|---|---|---|---|
| P₁′ | D_{(1, 1)} | D_{(2, 1)} | ffff |
| P₂′ | D_{(1, 2)} | D_{(2, 2)} | ffff |
| P₃′ | D_{(1, 3)} | D_{(2, 3)} | ffff |
| P₄′ | ffff | ffff | ffff |

After step S270, the processing unit 130 executes steps S240 and S250 again. Herein the distance D_{(2,1)} is assumed to be the minimum distance among all the valid distances D_{(i,j)} in table 12. Thus, in step S260, the processing unit 130 defines the current touch point P₁′ as a new touch point moved from the previous touch point P₂. Namely, in step S260, the index “1” of the current touch point P₁′ and the ID code “ID1” of the previous touch point P₂ are recorded into a recording medium (i.e., the current touch point P₁′ inherits the ID code “ID1” from the previous touch point P₂). After that, in step S270, the processing unit 130 defines the distances D_{(2,1)}, D_{(2,2)}, D_{(2,3)}, D_{(2,4)}, D_{(1,1)}, and D_{(3,1)} as invalid values, as shown in following table 13.

TABLE 13
distances D_{(i, j)} between previous touch
points Pᵢ and current touch points Pⱼ′

| | P₁ | P₂ | P₃ |
|---|---|---|---|
| P₁′ | ffff | ffff | ffff |
| P₂′ | D_{(1, 2)} | ffff | ffff |
| P₃′ | D_{(1, 3)} | ffff | ffff |
| P₄′ | ffff | ffff | ffff |

After step S270, the processing unit 130 executes steps S240 and S250 again. Herein the distance D_{(1,2)} is assumed to be the minimum distance among all the valid distances D_{(i,j)} in table 13. Thus, in step S260, the processing unit 130 defines the current touch point P₂′ as a new touch point moved from the previous touch point P₁. Namely, in step S260, the index “2” of the current touch point P₂′ and the ID code “ID2” of the previous touch point P₁ are recorded into a recording medium (i.e., the current touch point P₂′ inherits the ID code “ID2” from the previous touch point P₁). After that, in step S270, the processing unit 130 defines the distances D_{(1,1)}, D_{(1,2)}, D_{(1,3)}, D_{(1,4)}, D_{(2,2)}, and D_{(3,2)} as invalid values, as shown in following table 14.

TABLE 14
distances D_{(i, j)} between previous touch
points Pᵢ and current touch points Pⱼ′

| | P₁ | P₂ | P₃ |
|---|---|---|---|
| P₁′ | ffff | ffff | ffff |
| P₂′ | ffff | ffff | ffff |
| P₃′ | ffff | ffff | ffff |
| P₄′ | ffff | ffff | ffff |

After step S270, the processing unit 130 executes steps S240 and S250 again. Since there is no more valid distance among the distances D_{(i,j)} in table 14 (i.e., the processing unit 130 cannot find any minimum distance D_{(a,b)} among the distances D_{(i,j)}), the processing unit 130 obtains the detection result of the touch point movement (i.e., the result recorded in step S260). Based on the result recorded in step S260, the current touch points P₁′, P₂′, and P₄′ respectively inherit the ID codes “ID1”, “ID2”, and “ID3”, and the current touch point P₃′ does not inherit any ID code. After that, in step S280, the processing unit 130 correspondingly assigns a new ID code “ID4” to the current touch point P₄′.

In summary, in an embodiment of the invention, the distances D_{(i,j)} between all the previous touch points P₁ (i.e., P₁-Pₘ) and all the current touch points Pⱼ′ (i.e., P₁′-Pₙ′) are calculated, and a movement relationship between the previous touch points Pᵢ and the current touch points Pⱼ′ can be determined by analyzing these distances D_{(i,j)}.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for detecting a touch point movement, comprising:
detecting a touch panel to obtain positions of m previous touch points Pᵢ during a frame period, wherein m is an integer, and i is an integer between 1 and m;
detecting the touch panel to obtain positions of n current touch points Pⱼ′ during another frame period, wherein n is an integer, and j is an integer between 1 and n;
calculating distances D_{(i,j)} between the previous touch points Pᵢ and the current touch points Pⱼ′;
finding a minimum distance among valid ones of the distance D_{(i,j)}; and
when a distance D_{(a,b)} among the distances D_{(i,j)} is the minimum distance, defining the current touch point P_{b}′ as a touch point moved from the previous touch point Pₐ, and defining the distances D_{(a,1)}-D_{(a,n)} and the distances D_{(1,b)}-D_{(m,b)} as invalid values.

2. The method according to claim 1, wherein the step of defining the current touch point P_{b}′ as the touch point moved from the previous touch point Pₐ comprises:
allowing the current touch point P_{b}′ to inherit an identification (ID) code or an attribute from the previous touch point Pₐ.

3. The method according to claim 2, wherein when n is greater than m, at least one new ID code or at least one new attribute is correspondingly assigned to at least one of the current touch points Pⱼ′ that does not inherit any ID code or attribute.

4. The method according to claim 1 further comprising:
recording an index b of the current touch point P_{b}′ and an ID code or an attribute of the previous touch point Pₐ.

5. The method according to claim 1, wherein the step of defining the distances D_{(a,1)}-D_{(a,n)} and the distances D_{(1,b)}-D_{(m,b)} as invalid values comprises:
setting the distances D_{(a,1)}-D_{(a,n)} and the distances D_{(1,b)}-D_{(m,b)} to a maximum value.

6. The method according to claim 1 further comprising:
repeating the step of finding the minimum distance among valid ones of the distance D_{(i,j)} until all the distances D_{(i,j)} are defined as invalid values.

7. An apparatus for detecting a touch point movement, comprising:
a touch panel;
a driving unit, for driving and detecting the touch panel to output a detection result; and
a processing unit, for receiving the detection result, obtaining positions of m previous touch points Pᵢ during a frame period according to the detection result, obtaining positions of n current touch points Pⱼ′ during another frame period according to the detection result, calculating distances D_{(i,j)} between the previous touch points Pᵢ and the current touch points Pⱼ′, and finding a minimum distance among valid ones of the distances D_{(i,j)}, wherein m and n are integers, i is an integer between 1 and m, j is an integer between 1 and n, and when a distance D_{(a,b)} among the distances D_{(i,j)} is the minimum distance, the processing unit defines the current touch point P_{b}′ as a touch point moved from the previous touch point Pₐ and defines the distances D_{(a,1)}-D_{(a,n)} and the distances D_{(1,b)}-D_{(m,b)} as invalid values.

8. The apparatus according to claim 7, wherein the processing unit allows the current touch point P_{b}′ to inherit an ID code or an attribute from the previous touch point Pₐ.

9. The apparatus according to claim 8, wherein when n is greater than m, the processing unit correspondingly assigns at least one new ID code or at least one new attribute to at least one of the current touch points Pⱼ′ that does not inherit any ID code or attribute.

10. The apparatus according to claim 7, wherein the processing unit further records an index b of the current touch point P_{b}′ and an ID code or an attribute of the previous touch point Pₐ.

11. The apparatus according to claim 7, wherein the invalid values are a maximum value.

12. The apparatus according to claim 7, wherein the processing unit repeatedly finds the minimum distance among valid ones of the distances D_{(i,j)} until all the distances D_{(i,j)} are defined as invalid values.
